(19) United States
(12) Patent Application Publication
(10) Pub. No.: US 2005/0015630 A1
(43) Pub. Date: Jan. 20, 2005

(54) Personal authentication processing device, locking/unlocking management apparatus, and locking/unlocking management system

(76) Inventors: Manabu Yumoto, Nara-shi (JP); Manabu Onozaki, Nara-shi (JP)

Correspondence Address: HARNESS, DICKEY & PIERCE, P.L.C., P.O. BOX 8910, RESTON, VA, 20195, US

(21) Appl. No.: 10/855,420

(22) Filed: May 28, 2004

(30) Foreign Application Priority Data
May 30, 2003 (JP) 2003-155697

(51) Int. Cl. H04L 9/32

(52) U.S. Cl. 713/202; 382/115

(57) ABSTRACT

A personal authentication processing device comprises: a personal biometric information storage section which stores predetermined personal biometric information; and a personal authentication processing section for receiving personal biometric information, performing personal authentication by comparing the received personal biometric information and the predetermined personal biometric information which is stored in the personal biometric information storage section, and outputting a true/false signal which indicates whether a result of the personal authentication is true or false.

This Nonprovisional application claims priority under 35 U.S.C. §119(a) on Patent Application No. 2003-155697 filed in Japan on May 30, 2003, the entire contents of which are hereby incorporated by reference.

### BACKGROUND OF THE INVENTION

1. Field of the Invention

The present invention relates to a personal authentication processing device, a locking/unlocking management apparatus and a locking/unlocking management system. More specifically, the present invention relates to a personal authentication processing device used in an electronic lock or the like for entering/exiting a room, a locking/unlocking management apparatus used in a specific area entering/exiting apparatus or the like, and a locking/unlocking management system used in a specific area entering/exiting management system or the like using the same.

2. Description of the Related Art

A specific area entering/exiting management system manages permission and prohibition of users entering/exiting a specific area, such as a room, by a personal authentication of the user. An example of such a system is shown in Japanese Laid-Open Publication No. 2000-137844.

FIG. 5 is a block diagram showing a structure of a conventional specific area entering/exiting management system 500.

The specific area entering/exiting management system 500 comprises a personal authentication processing device 501 and a specific area entering/exiting management apparatus 502.

The personal authentication processing device 501 may be a card, for example. The personal authentication processing device 501 includes a first personal identification information storage section 503. The first personal identification information storage section 503 stores personal identification information such as an ID number given to an owner of the personal authentication processing device 501.

The specific area entering/exiting management apparatus 502 is a gate apparatus provided near an entrance/exit of a specific area, for example. The specific area entering/exiting management apparatus 502 performs a personal authentication of a user by using personal identification information stored in the first personal identification information storage section 503 of the personal authentication processing device 501, and, based on the result, permits or prohibits the user to enter/exit a specific area.

The specific area entering/exiting management apparatus 502 includes a sensor section 504, a reference personal identification biometric information storage section 505, a personal authentication processing section 506, and a specific area entering/existing control section 507.

The sensor section 504 senses personal biometric information of a user and outputs the personal biometric information to the personal authentication processing section 506, and also reads the stored personal identification information from the personal authentication processing device 501.

The reference personal identification biometric information storage section 505 includes a second personal identification information storage section 508 and a reference personal biometric information storage section 509.

The second personal identification information storage section 508 stores the pre-stored personal identification information of the user read by the sensor section 504. The reference personal biometric information storage section 509 stores users personal biometric information which is linked to personal identification information (for example, ID information).

The reference personal identification biometric information storage section 505 reads the personal biometric information, which is linked to the personal identification information stored in the second personal identification information storage section 508, from the reference personal biometric information storage section 509. It then outputs the personal identification information to the personal authentication processing section 506.

The personal authentication processing section 506 performs personal authentication using the personal biometric information sensed by the sensor section 504, and the personal biometric information read by the reference personal identification biometric information storage section 505.

The specific area entering/existing control section 507 controls a specific area entrance/exit 510 (for example, an automatic door) by personal authentication of a user.

Now, an operation of the specific area entering/exiting management system 500 will be described.

First, when a user wants to enter/exit a specific area such as a room, the user inserts, for example, the personal authentication processing device 501 (for example, a card), into an insertion slot of the specific area entering/exiting management apparatus 502 (for example, a gate apparatus).

After the personal authentication processing device 501 is inserted into the insertion slot of the specific area entering/exiting management apparatus 502, the sensor section 504 of the specific area entering/exiting management apparatus 502 reads personal identification information from the first personal identification information storage section 503 of the inserted personal authentication processing device 501, and also senses personal biometric information of the user. Then, the sensor section 504 outputs the read personal identification information to the reference personal identification biometric information storage section 505 and also outputs the sensed personal biometric information to the personal authentication processing section 506.

In the reference personal identification biometric information storage section 505, the personal identification information output from the sensor section 504 is stored in the second personal identification information storage section 508. The personal biometric information which is linked to the stored personal identification information is read from the reference personal biometric information storage section 509. The read personal biometric information is output to the personal authentication processing section 506. The reference personal biometric information storage section 509 may be provided in a host computer (not shown) connected to the specific area entering/exiting management apparatus 502 instead of the reference personal identification biometric information storage section 505 of the specific area entering/exiting management apparatus 502.

The personal authentication processing section 506 performs personal authentication by comparing the personal biometric information read from the reference personal biometric information storage section 509 and the personal biometric information sensed by the sensor section 504.

When the personal biometric information read from the reference personal biometric information storage section 509 and the personal biometric information sensed by the sensor section 504 match, the personal authentication processing section 506 outputs a match signal to the specific area entering/existing control section 507. The match signal indicates that the two personal biometric information match each other. When the specific area entering/existing control section 507 receives the match signal, which indicates that the two the personal biometric information match each other, the specific area entering/existing control section 507 controls the specific area entrance/exit 510 to permit the user to enter/exit the specific area. For example, if the specific area entrance/exit 510 is an automatic door, the automatic door which is closed is opened and the user can enter/exit the specific area.

When the personal biometric information read from the reference personal biometric information storage section 509 and the personal biometric information sensed by the sensor section 504 do not match, the personal authentication processing section 506 outputs a mismatch signal to the specific area entering/existing control section 507. The mismatch signal indicates that the two the personal biometric information do not match each other. When the specific area entering/existing control section 507 receives the mismatch signal, the specific area entering/existing control section 507 controls the specific area entrance/exit 510 to prohibit the user to enter/exit the specific area. For example, when the specific area entrance/exit 510 is an automatic door, the automatic door is kept locked while being closed and the user cannot enter/exit the specific area.

Japanese Laid-Open Publication No. 11-338985 discloses another conventional example, which is a card used in a specific area entering/exiting management system.

The card is used with a specific area entering/exiting management apparatus. The specific area entering/exiting management apparatus manages users entering/existing a specific area by confirming personal identification information from the card.

The card includes: a reference personal identification information storage section in which personal identification information such as, ID information, and personal biometric information such as, a fingerprint, are stored; a personal authentication processing section; and a sensor section. When the user wants to enter/exit a specific area, personal biometric information of the user is sensed by the sensor section in the card. The personal authentication is performed by the personal authentication processing section using the sensed personal biometric information and the stored personal biometric information.

In the case where the personal biometric information read from the reference personal identification information storage section, and the personal biometric information sensed by the sensor section match, as a result of the personal authentication, the personal identification information is output from the card to the specific area entering/exiting management apparatus. The specific area entering/exiting management apparatus compares the input personal identification information and the stored personal identification information. When the input personal identification information matches the stored personal identification information as a result of comparison, a specific area entering/existing control section controls an entrance/exit of the specific area to permit the user to freely enter/exit the specific area.

When the personal biometric information read from the reference personal identification information storage section, and the personal biometric information sensed by the sensor section do not match, as a result of the personal authentication, the personal identification information is not output to the specific area entering/exiting management apparatus. Thus, the specific area entering/existing management apparatus does not operate and functions to prohibit the user from freely entering/exiting the specific area.

However, the conventional examples have the following problems as described below. In the case of the specific area entering/exiting management system described in Japanese Laid-Open Publication No. 2000-137844, the reference personal biometric information storage section of the specific area entering/exiting management apparatus stores the personal biometric information, which is linked to the personal identification information. Thus, if both the personal identification information and the personal biometric information are stolen, lost, leaked, or the like, a malicious person could obtain such information, and the information may be undesirably abused (to open/close an automatic door) by a person pretending to be a genuine owner.

In the case of the card described in Japanese Laid-Open Publication No. 11-338985, the card stores both the personal biometric information for performing personal authentication, and the personal identification information for controlling the specific area entering/exiting management apparatus, which is output to the specific area entering/exiting management apparatus in accordance with the result of the personal authentication. In this case, the personal authentication is performed within the card, but the specific area entering/existing management apparatus is controlled by the personal identification information. Thus, if the personal identification information is stolen, lost, leaked, or the like, a malicious person could obtain such information, and the information may be undesirably abused (to open/close an automatic door) by a person pretending to be a genuine owner.

### SUMMARY OF THE INVENTION

According to one aspect of the present invention, there is provided a personal authentication processing device comprising: a personal biometric information storage section which stores predetermined personal biometric information; and a personal authentication processing section for receiving personal biometric information, performing personal authentication by comparing the received personal biometric information and the predetermined personal biometric information which is stored in the personal biometric information storage section, and outputting a true/false signal which indicates whether a result of the personal authentication is true or false.

In one embodiment of the present invention, the personal biometric information may be input to the personal authentication processing section in contact therewith or without contact therewith, the personal authentication processing section may output a match signal as the true/false signal when the received personal biometric information matches the predetermined personal biometric information, and output a mismatch signal as the true/false signal when the received personal biometric information does not match the predetermined personal biometric information.

In one embodiment of the present invention, the personal authentication processing device may further comprise a sensor section for sensing the personal biometric information and outputting the sensed personal biometric information to the personal authentication processing section.

In one embodiment of the present invention, the personal authentication processing section may output a match signal as the true/false signal when the received personal biometric information matches the predetermined personal biometric information, and output a mismatch signal as the true/false signal when the received personal biometric information does not match the predetermined personal biometric information.

In one embodiment of the present invention, the personal authentication processing device may be formed of a card device or a portable electronic device.

In one embodiment of the present invention, the personal biometric information may be at least one of fingerprint information, eye retina information, voiceprint information, and face image information.

According to another aspect of this invention, there is provided a locking/unlocking management apparatus comprising a locking/unlocking control section for receiving a true/false signal which indicates whether a result of personal authentication using personal biometric information is true or false, and performing a locking/unlocking permission or prohibition process in accordance with the true/false signal.

In one embodiment of the present invention, the locking/unlocking management apparatus may further comprise a sensor section for sensing personal biometric information for the personal authentication.

In one embodiment of the present invention, the locking/unlocking control section may perform the locking/unlocking permission process when the true/false signal is a match signal which indicates that the result of the personal authentication is true, and the locking/unlocking control section may perform the locking/unlocking prohibition process when the true/false signal is a mismatch signal which indicates that the result of the personal authentication is false.

In one embodiment of the present invention, the locking/unlocking permission or prohibition process may be a gate opening/closing control process.

In one embodiment of the present invention, the personal biometric information may be at least one of fingerprint information, eye retina information, voiceprint information, and face image information.

According to still another aspect of this invention, there is provided a locking/unlocking management system comprising a personal authentication processing device and a locking/unlocking management apparatus, wherein: the personal authentication processing device includes a personal biometric information storage section which stores predetermined personal biometric information, and a personal authentication processing section for receiving personal biometric information, performing personal authentication by comparing the received personal biometric information and the predetermined personal biometric information which is stored in the personal biometric information storage section, and outputting a true/false signal which indicates whether a result of the personal authentication is true or false; and the locking/unlocking management apparatus includes a lock opening/closing control section for receiving the true/false signal and for performing a locking/unlocking permission or prohibition process in accordance with the true/false signal.

In one embodiment of the present invention, the personal authentication processing device may further include a sensor section for sensing the personal biometric information and outputting the sensed personal biometric information to the personal authentication processing section.

In one embodiment of the present invention, the locking/unlocking management apparatus may further include a sensor section for sensing the personal biometric information and outputting the sensed personal biometric information to the personal authentication processing section.

Now, a function caused by the present invention according to the above-described structure will be described.

In a conventional system, which manages people entering/exiting by personal authentication, the ID information of the person and the personal biometric information (for example, a fingerprint, voiceprint, a face image or the like) of the person are always used together (and are linked to each other). In such a system, there is a risk that the information (for example, a fingerprint and ID information) is stolen.

On the other hand, according to the present invention, only personal biometric information is checked within a personal authentication processing device kept by a user to perform personal authentication every time the user enters/exits. The personal authentication processing device is, for example, a card device, a portable electronic device, or the like. Thus, a high-level security of personal authentication can be achieved even for the case where personal biometric information is leaked.

In such an example, there is a case where a sensor section for sensing personal biometric information for authenticating the person is provided in a card device or a portable electronic device which keeps pre-stored personal biometric information. Also, there is a case where the sensor section is provided in a locking/unlocking management apparatus, such as a specific area entering/exiting management apparatus instead of a card device or a portable electronic device.

In current techniques, the size of a sensor section for sensing personal biometric information for personal authentication is large. Thus, there may be technical problems in implementing the case where the sensor section is provided in the portable device when minitualization is intended. Therefore, the case where the sensor section is provided in the locking/unlocking management apparatus such as a specific area entering/exiting management apparatus can be implemented more readily using current techniques.

According to the present invention, in a card device such as an IC card, or a portable electronic device, the pre-stored personal biometric information (for example, a fingerprint, voiceprint or the like) is stored in a personal biometric information storage section regardless of where the sensor section is provided. The pre-stored information is set to have an extremely high level of security. Thus, the pre-stored information cannot be readily read out or rewritten. In other words, the pre-stored information is set to be difficult to be analyzed. Further, the ID information of the person is not present in the card device (such as an IC card) or a portable electronic device.

A card device such as an IC card or a portable electronic device stores personal biometric information. Every time the personal authentication is performed, this pre-stored personal biometric information is compared with personal biometric information measured by the sensor section, which is provided in the locking/unlocking management apparatus, such as a specific area entering/exiting management apparatus, by communicating data. Thus, there is a risk that information is read during such a process. Therefore, from this viewpoint, the case where the sensor section is in a card device or a portable electronic device is more advantageous with respect to security, compared to the case where the sensor section is in the locking/unlocking management apparatus.

In the case where the sensor section is provided in a locking/unlocking management apparatus, any person can touch the locking/unlocking management apparatus (specific area entering/exiting control apparatus such as a gate apparatus). Therefore, there is a risk that personal biometric information such as a fingerprint left on a surface of the sensor section is stolen. Therefore, from this viewpoint, the case where the sensor section is in a card device or a portable electronic device is more advantageous with respect to security, compared to the case where the sensor section is in the locking/unlocking management apparatus.

Thus, the invention described herein makes possible the advantages of providing a personal authentication processing device, locking/unlocking management apparatus, and a locking/unlocking management system using the same, which can prevent locking/unlocking by a person pretending to be a genuine owner.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing a structure of a specific area entering/exiting management system according to Example 1 of the present invention;

FIG. 2 is a flow diagram illustrating an operation of the specific area entering/exiting management system according to Example 1;

FIG. 3 is a block diagram showing a structure of a specific area entering/exiting management system according to Example 2 of the present invention;

FIG. 4 is a flow diagram illustrating an operation of the specific area entering/exiting management system according to Example 2; and

FIG. 5 is a block diagram showing a structure of a conventional specific area entering/exiting management system.

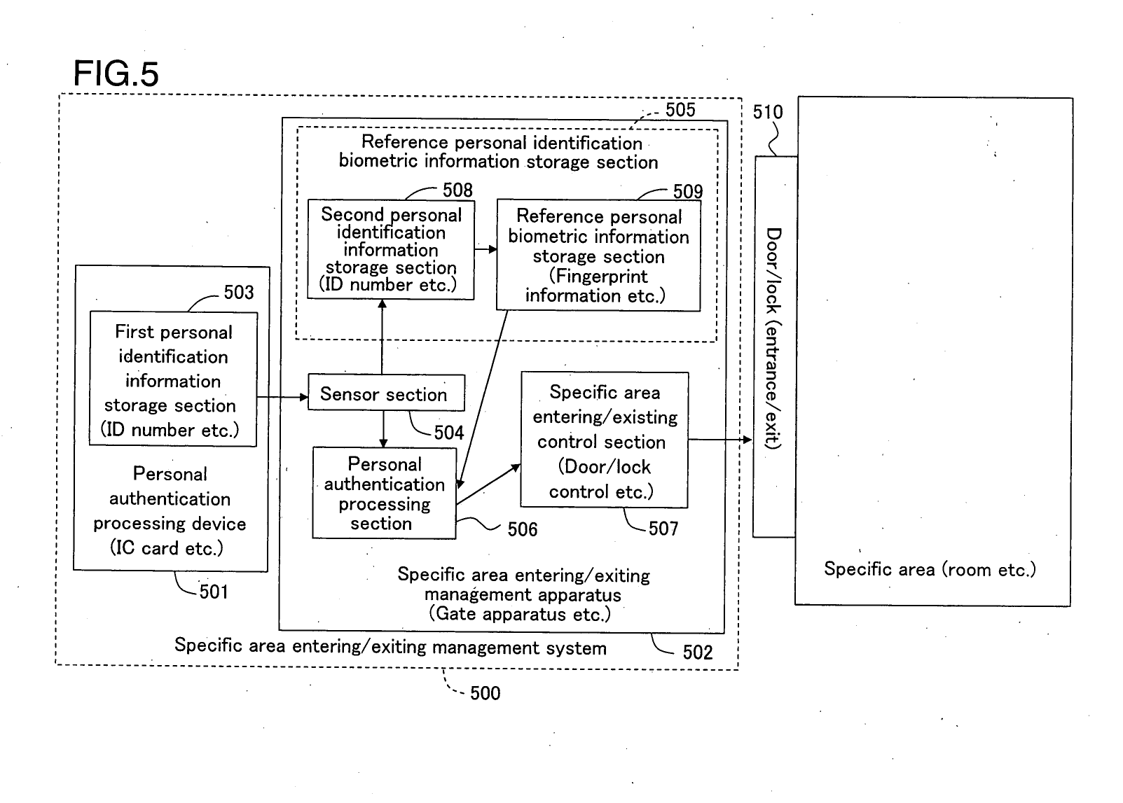

### DESCRIPTION OF THE PREFERRED EMBODIMENTS

Hereinafter, a personal authentication processing device, a locking/unlocking management apparatus, and a locking/unlocking management system using the same according to the present invention will be described in detail with reference to the drawings. In Examples 1 and 2 described below, the locking/unlocking management apparatus is applied to a specific area entering/exiting management apparatus, and the locking/unlocking management system using the above device and apparatus is applied to a specific area entering/exiting management system.

### EXAMPLE 1

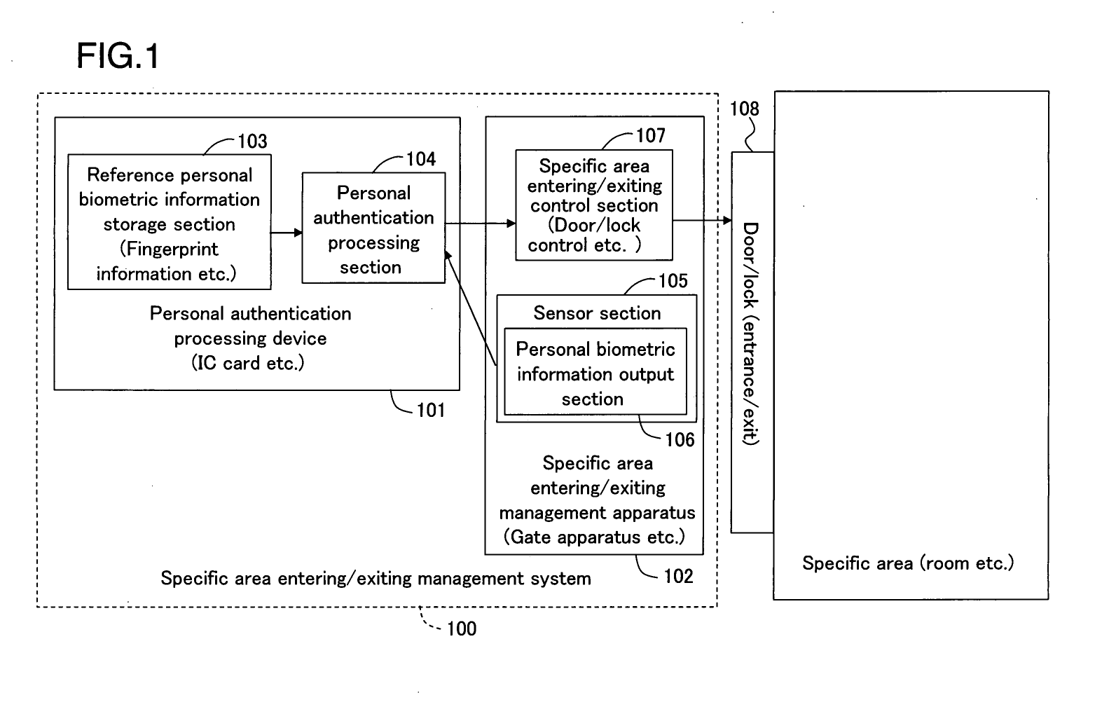

FIG. 1 is a block diagram showing a structure of a specific area entering/exiting management system 100 according to Example 1 of the present invention.

In FIG. 1, the specific area entering/exiting management system 100 includes a personal authentication processing device 101 and a specific area entering/exiting management apparatus 102.

The personal authentication processing device 101 includes a reference personal biometric information storage section 103 and a personal authentication processing section 104. The personal identification processing apparatus 101 is, for example, a card device (IC card, magnetic card and the like) or a portable electronic device (mobile phone, personal digital assistant (PDA), and the like).

The reference personal biometric information storage section 103 stores predetermined personal biometric information of an owner (user) of the personal authentication processing device 101. The personal biometric information is, for example, fingerprint information (fingerprint data or fingerprint-derived information), eye retina information (retina data or retina-derived information), voiceprint information (voiceprint data or voiceprint-derived information), or face image information (a face image or face image-derived information). Herein, the derived-information means information obtained by selecting particular characteristics of a fingerprint, a retina, a voiceprint, a face image or the like. The derived-information is, for example, information indicating features and frequency characteristics.

The personal authentication processing section 104 receives personal biometric information from outside, and compares the received personal biometric information with the pre-stored personal biometric information in the reference personal biometric information storage section 103, so as to perform personal authentication (including identification of a genuine card owner). The personal authentication processing section 104 outputs a true/false signal, which indicates whether the result of the personal authentication is true or false, to the specific area entering/exiting management apparatus 102.

The specific area entering/exiting management apparatus 102 includes a sensor section 105 and a specific area entering/exiting control section 107. The specific area entering/exiting management apparatus 102 is, for example, a gate apparatus provided near an entrance/exit of the specific area. The gate apparatus performs a process of permitting or prohibiting entering/exiting the specified area in accordance with the true/false signal which has been input from the outside. The gate apparatus controls opening/closing of the gate of the entrance/exit of the specified area based on the permission or prohibition process.

The sensor section 105 senses personal biometric information of a user. The sensor section 105 includes a personal biometric information output section 106. The personal biometric information output section 106 outputs the personal biometric information sensed by the sensor section 105 in contact with the personal authentication processing device 101. Alternatively, the personal biometric information output section 106 may output the personal biometric information sensed by the sensor section 105 to the personal authentication processing device 101 without contact (for example, by radio waves).

The specific area entering/exiting control section 107 receives the true/false signal which indicates whether the result of the personal authentication using the sensed personal biometric information is true or false. The specific area entering/exiting control section 107 controls opening/closing of a specific area entrance/exit 108 (for example, an automatic door) in accordance with the received true/false signal. The specific area entering/exiting control section 107 is one form of a locking/unlocking control section.

Hereinafter, an operation of the specific area entering/exiting management system 100 will be described.

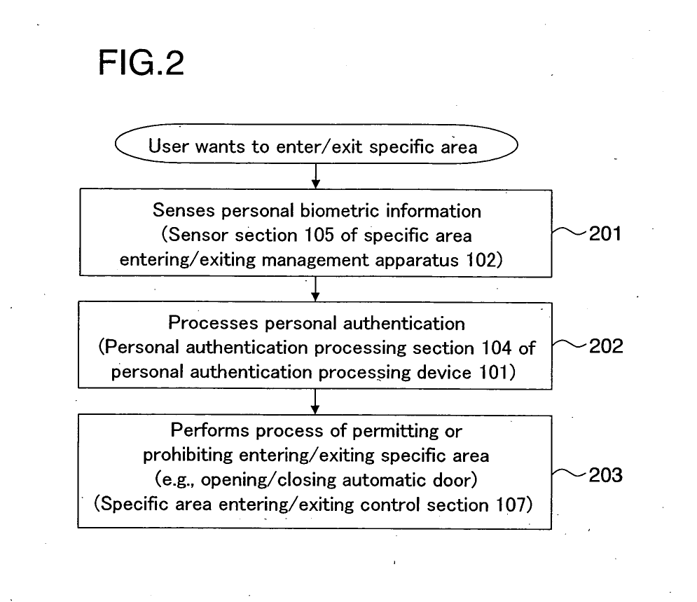

FIG. 2 is a flow diagram illustrating an operation of the specific area entering/exiting management system 100 shown in FIG. 1.

As shown in FIG. 2, when a user wants to enter/exit the specific area, the user touches the sensor section 105 of the specific area entering/exiting management apparatus 102, for example, with a portion of the body (a fingerprint). The sensor section 105 touched by the portion of the body senses personal biometric information (for example, fingerprint information) of the user (step S201).

Herein, the sensor section 105 is explained to be touched by the portion of the body of the user. However, this is merely an example, and the sensor section 105 may be activated in a different manner.

Then, the user brings the personal authentication processing device 101 into contact with the specific area entering/exiting management apparatus 102. For example, the user inserts the personal authentication processing device 101 into a specifically provided insertion slot, which is provided in the specific area entering/exiting management apparatus 102.

When the personal authentication processing device 101 is in contact with a connection portion of the specific area entering/exiting management apparatus 102, the personal biometric information output section 106 of the specific area entering/exiting management apparatus 102 outputs, the personal biometric information sensed by the sensor section 105, to the personal authentication processing device 101.

Thus, the personal authentication processing device 101 receives the personal biometric information from outside. More specifically, the personal biometric information is input to the personal authentication processing section 104 of the personal authentication processing device 101. The personal authentication processing section 104 compares the input personal biometric information with pre-stored personal biometric information, which is stored in the reference personal biometric information storage section 103, to perform personal authentication (step S202).

As a result of comparison, when the input personal biometric information and the pre-stored biometric information read from the reference personal biometric information storage section 103 match, the personal authentication processing section 104 outputs a match signal to the specific area entering/exiting management apparatus 102 as the true/false signal. The match signal indicates that the two personal biometric information match and the result of personal authentication is true. The match signal is input to the specific area entering/exiting control section 107 of the specific area entering/exiting management apparatus 102.

When the match signal is input, the specific area entering/exiting control section 107 controls the specific area entrance/exit 108 to perform a process of permitting the user to enter/exit the specific area. For example, if the specific area entrance/exit 108 is an automatic door, an electronic lock provided on the automatic door is opened. The automatic door is actuated and opened. The user can freely enter/exit the specific area (step S203).

As a result of comparison, when the input personal biometric information and the pre-stored personal biometric information read from the reference personal biometric information storage section 103 do not match, the personal authentication processing section 104 outputs a mismatch signal to the specific area entering/exiting management apparatus 102 as the true/false signal. The mismatch signal indicates that the two personal biometric information do not match and the result of the personal authentication is false. The mismatch signal is input to the specific area entering/exiting control section 107 in the specific area entering/exiting management apparatus 102.

When the mismatch signal is input, the specific area entering/exiting control section 107 controls the specific area entrance/exit 108 to perform a process of prohibiting the user to enter/exit the specific area. For example, if the specific area entrance/exit 108 is an automatic door, an electronic lock provided on the automatic door is kept locked. The automatic door is not actuated and is kept closed. The user cannot freely enter/exit the specific area (step S203).

Herein, after the sensed personal biometric information is input from the specific area entering/exiting management apparatus 102 to the personal authentication processing device 101, the user may keep the personal authentication processing device 101 in contact with the specific area entering/exiting management apparatus 102 so that the true/false signal can be output from the personal authentication processing device 101 to the specific area entering/exiting management apparatus 102. Alternatively, after the sensed personal biometric information is input from the specific area entering/exiting management apparatus 102 to the personal authentication processing device 101, the user may remove the personal authentication processing device 101 from the specific area entering/exiting management apparatus 102, and again bring the personal authentication processing device 101 into contact with the specific area entering/exiting management apparatus 102, when the user enters/exits the specific area.

The above-described authentication procedure of the specific area entering/exiting management system 100 may be described on the personal authentication processing device 101 to allow the user to understand the procedure at a glance, or may be described on or near the specific area entering/exiting management apparatus 102. Alternatively, an operation guidance section for displaying the authentication procedure of the specific area entering/exiting management system 100 in a manner similar to an electric bulletin board may be provided on the personal authentication processing device 101 or on the specific area entering/exiting management apparatus 102.

As described above, according to Example 1, the sensor section 105, touched by a specific portion of the user (for example, a fingerprint) or the like, senses personal biometric information of the user. When the personal authentication processing device 101 is in contact with the specific area entering/exiting management apparatus 102 at a predetermined position, the personal biometric information sensed by the sensor section 105 is input from the specific area entering/exiting management apparatus 102 to the personal authentication processing device 101. The personal biometric information input to the personal authentication processing device 101 is received by the personal authentication processing section 104. The personal authentication processing section 104 performs personal authentication of the user by comparing the input personal biometric information and the pre-stored personal biometric information, which is stored in the reference personal biometric information storage section 103. The result of the personal authentication is output to the specific area entering/exiting management apparatus 102. The specific area entering/exiting management apparatus 102 opens the door only when the result of the personal authentication is true. Therefore, the present invention can provide the specific area entering/exiting management system with high-level security with respect to leakage of personal information.

### EXAMPLE 2

In Example 1, a sensor section for sensing personal biometric information is provided in a specific area entering/exiting management apparatus. However, the present invention is not limited to such an example. In Example 2, a sensor section is provided in a personal authentication processing device.

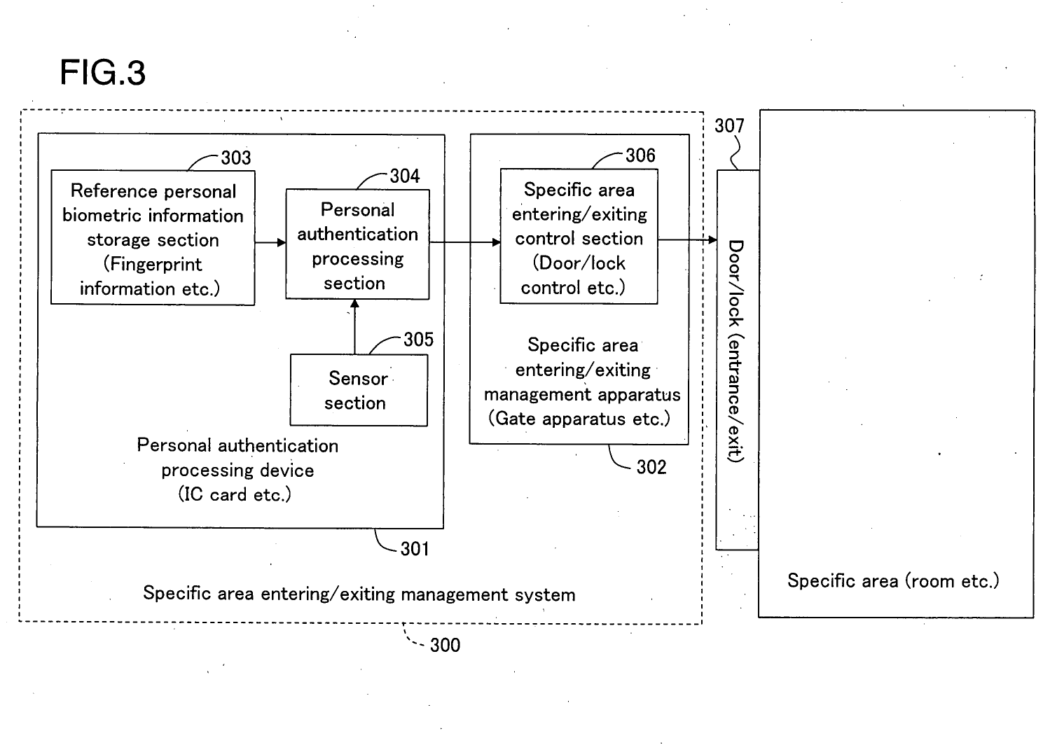

FIG. 3 is a block diagram showing a structure of a specific area entering/exiting management system 300 according to Example 2 of the present invention.

In FIG. 3, the specific area entering/exiting management system 300 includes a personal authentication processing device 301 and a specific area entering/exiting management apparatus 302.

The personal authentication processing device 301 includes a reference personal biometric information storage section 303, a personal authentication processing section 304, and a sensor section 305. The personal identification processing apparatus 301 is, for example, a card device (IC card, magnetic card and the like) or a portable electronic device (mobile phone, personal digital assistant (PDA), and the like).

The reference personal biometric information storage section 303 stores predetermined personal biometric information of an owner (user) of the personal authentication processing device 301. The personal biometric information is, for example, fingerprint information (fingerprint data or fingerprint-derived information), eye retina information (retina data or retina-derived information), voiceprint information (voiceprint data or voiceprint-derived information), or face image information (a face image or face image-derived information). Herein, the derived-information means information obtained by selecting particular characteristics of a fingerprint, a retina, a voiceprint, a face image or the like. The derived-information is, for example, information indicating features and frequency characteristics.

The sensor section 305 senses personal biometric information of a user.

The personal authentication processing section 304 compares the personal biometric information sensed by the sensor section 305 with the pre-stored personal biometric information, which is stored in the reference personal biometric information storage section 303, to perform personal authentication (including identification of a genuine card owner). The personal authentication processing section 304 outputs a true/false signal which indicates whether the result of the personal authentication is true or false to the specific area entering/exiting management apparatus 302.

The specific area entering/exiting management apparatus 302 includes a specific area entering/exiting control section 306. The specific area entering/exiting management apparatus 302 is, for example, a gate apparatus provided near an entrance/exit of the specific area. The gate apparatus performs a process of permitting or prohibiting entering/exiting the specified area in accordance with the true/false signal which has been input from the outside. The gate apparatus controls opening/closing of the gate of the entrance/exit of the specified area, based on the permission or prohibition process.

The specific area entering/exiting control section 306 receives the true/false signal which indicates whether the result of the personal authentication using the sensed personal biometric information is true or false. The specific area entering/exiting control section 306 controls opening/closing of a specific area entrance/exit 307 (for example, an automatic door) in accordance with the received true/false signal. The specific area entering/exiting control section 306 is one form of a locking/unlocking control section.

Hereinafter, an operation of the specific area entering/exiting management system 300 will be described.

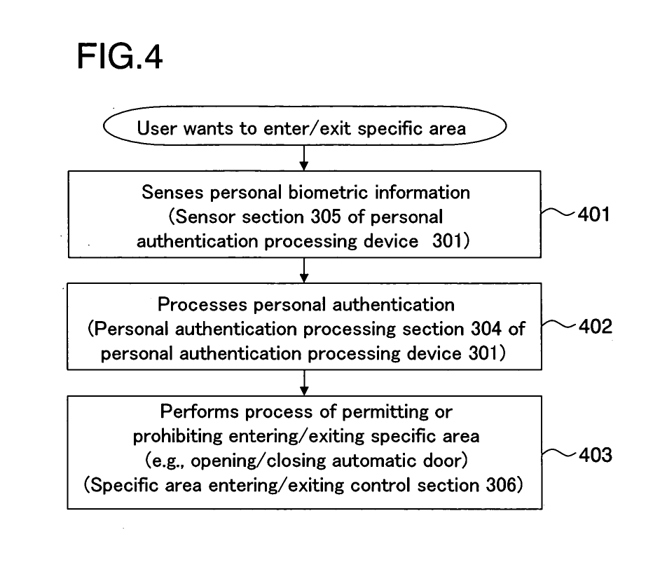

FIG. 4 is a flow diagram illustrating an operation of the specific area entering/exiting management system 300 shown in FIG. 3.

As shown in FIG. 4, when a user wants to enter/exit the specific area, the user touches the sensor section 305 of the personal authentication processing device 301, for example, with a portion of the body (for example, a fingerprint). The sensor section 305 touched by the portion of the body senses personal biometric information (for example, fingerprint information) of the user (step S401).

Herein, the sensor section 305 is explained to be touched by the portion of the body of the user. However, this is merely an example, and the sensor section 305 may be activated in a different manner.

The sensed personal biometric information is input to the personal authentication processing section 304. The personal authentication processing section 304 compares the input personal biometric information with pre-stored personal biometric information in the reference personal biometric information storage section 303 to perform personal authentication (step S402).

Then, the user brings the personal authentication processing device 301 into contact with the specific area entering/exiting management apparatus 302. For example, the user inserts the personal authentication processing device 301 into a specifically provided insertion slot provided in the specific area entering/exiting management apparatus 302.

As a result of comparison, when the input personal biometric information and the pre-stored biometric information read from the reference personal biometric information storage section 303 match, the personal authentication processing section 304 outputs a match signal to the specific area entering/exiting management apparatus 302 as the true/false signal. The match signal indicates that the two personal biometric information match and the result of personal authentication is true. The match signal is input to the specific area entering/exiting control section 306 of the specific area entering/exiting management apparatus 302.

When the match signal is input, the specific area entering/exiting control section 306 controls the specific area entrance/exit 307 to perform a process of permitting the user to enter/exit the specific area. For example, if the specific area entrance/exit 307 is an automatic door, an electronic lock provided on the automatic door is opened. The automatic door is actuated and opened, and the user can freely enter/exit the specific area (step S403).

As a result of comparison, when the input personal biometric information and the pre-stored personal biometric information read from the reference personal biometric information storage section 303 do not match, the personal authentication processing section 304 outputs a mismatch signal to the specific area entering/exiting management apparatus 302 as the true/false signal. The mismatch signal indicates that the two personal biometric information do not match and the result of the personal authentication is false. The mismatch signal is input to the specific area entering/exiting control section 306 in the specific area entering/exiting management apparatus 302.

When the mismatch signal is input, the specific area entering/exiting control section 306 controls the specific area entrance/exit 307 to perform a process of prohibiting the user to enter/exit the specific area. For example, if the specific area entrance/exit 307 is an automatic door, an electronic lock provided on the automatic door is kept locked. The automatic door is not actuated and is kept closed, and the user cannot freely enter/exit the specific area (step S403).

In Example 2, the sensor section is provided in the personal authentication processing device such as an IC card device possessed by the user instead of the specific area entering/exiting management apparatus such as a gate apparatus which can be touched by any person. Thus, it is possible to prevent leakage of the personal biometric information such as a fingerprint left on a surface of the sensor section.

Examples 1 and 2 have been explained with respect to the specific area entering/existing management system. However, the present invention is not limited to this, and the locking/unlocking management system of the present invention can be applied to anything using a locking/unlocking mechanism (for example, a bicycle, an automobile, a locker, or the like).

Communicating information between the personal authentication processing device and the locking/unlocking management apparatus may be performed not only by bringing the personal authentication processing device into contact with the locking/unlocking management apparatus, but also by using non-contact measures, such as radio waves. In such a case, it is required to provide communication means in both the personal authentication processing device and the locking/unlocking management apparatus.

Examples 1 and 2 are intended to be illustrative in all aspects, rather than to be limiting. The technical scope of the present invention is indicated by the claims. The equivalents of the claims and all modifications within the claims are within in the technical scope of the present invention.

As described above, according to the present invention, personal authentication can be performed within a personal authentication processing device kept by a user. As a result, high-level security can be achieved with respect to personal authentication even for the case where personal biometric information is leaked.

Further, according to the present invention, locking/unlocking can be managed by using only personal biometric information (for example, a fingerprint) with high-level security and without using personal identification information (for example, ID information) with low-level security.

The present invention can provide a personal authentication processing device, a locking/unlocking management apparatus, and a locking/unlocking management system using the same, which can prevent locking/unlocking by a person pretending to be a genuine owner.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

1. A personal authentication processing device comprising:
a personal biometric information storage section which stores predetermined personal biometric information; and
a personal authentication processing section for receiving personal biometric information, performing personal authentication by comparing the received personal biometric information and the predetermined personal biometric information which is stored in the personal biometric information storage section, and outputting a true/false signal which indicates whether a result of the personal authentication is true or false.

2. A personal authentication processing device according to claim 1, wherein:
the personal biometric information is input to the personal authentication processing section in contact therewith or without contact therewith;
the personal authentication processing section outputs a match signal as the true/false signal when the received personal biometric information matches the predetermined personal biometric information, and outputs a mismatch signal as the true/false signal when the received personal biometric information does not match the predetermined personal biometric information.

3. A personal authentication processing device according to claim 1, further comprising a sensor section for sensing the personal biometric information and outputting the sensed personal biometric information to the personal authentication processing section.

4. A personal authentication processing device according to claim 3, wherein the personal authentication processing section outputs a match signal as the true/false signal when the received personal biometric information matches the predetermined personal biometric information, and outputs a mismatch signal as the true/false signal when the received personal biometric information does not match the predetermined personal biometric information.

5. A personal authentication processing device according to claim 1, wherein the personal authentication processing device is formed of a card device or a portable electronic device.

6. A personal authentication processing device according to claim 1, wherein the personal biometric information is at least one of fingerprint information, eye retina information, voiceprint information, and face image information.

7. A locking/unlocking management apparatus comprising a locking/unlocking control section for receiving a true/false signal which indicates whether a result of personal authentication using personal biometric information is true or false, and performing a locking/unlocking permission or prohibition process in accordance with the true/false signal.

8. A locking/unlocking management apparatus according to claim 7, further comprising a sensor section for sensing personal biometric information for the personal authentication.

9. A locking/unlocking management apparatus according to claim 7, wherein the locking/unlocking control section performs the locking/unlocking permission process when the true/false signal is a match signal which indicates that the result of the personal authentication is true, and the locking/unlocking control section performs the locking/unlocking prohibition process when the true/false signal is a mismatch signal which indicates that the result of the personal authentication is false.

10. A locking/unlocking management apparatus according to claim 7, wherein the locking/unlocking permission or prohibition process is a gate opening/closing control process.

11. A locking/unlocking management apparatus according to claim 7, wherein the personal biometric information is at least one of fingerprint information, eye retina information, voiceprint information, and face image information.

12. A locking/unlocking management system comprising a personal authentication processing device and a locking/unlocking management apparatus, wherein:
the personal authentication processing device includes
a personal biometric information storage section which stores predetermined personal biometric information, and
a personal authentication processing section for receiving personal biometric information, performing personal authentication by comparing the received personal biometric information and the predetermined personal biometric information which is stored in the personal biometric information storage section, and outputting a true/false signal which indicates whether a result of the personal authentication is true or false; and
the locking/unlocking management apparatus includes a lock opening/closing control section for receiving the true/false signal and for performing a locking/unlocking permission or prohibition process in accordance with the true/false signal.

13. A locking/unlocking management system according to claim 12, wherein the personal authentication processing device further includes a sensor section for sensing the personal biometric information and outputting the sensed personal biometric information to the personal authentication processing section.

14. A locking/unlocking management system according to claim 12, wherein the locking/unlocking management apparatus further includes a sensor section for sensing the personal biometric information and outputting the sensed personal biometric information to the personal authentication processing section.
